(19) United States
(12) Patent Application Publication
(10) Pub. No.: US 2011/0020620 A1
(43) Pub. Date: Jan. 27, 2011

(54) TRANSFER-FOIL RAW FABRIC HAVING NO FOIL FALL AND PEELING FILM THEREFOR

(76) Inventor: Kentaro Fujii, Kyoto-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/935,404

(22) PCT Filed: Jul. 31, 2009
(86) PCT No.: PCT/JP2009/063637

§ 371 Date: Sep. 29, 2010

(30) Foreign Application Priority Data
Aug. 13, 2008 (JP) 2008-208759
Oct. 31, 2008 (JP) 2008-280647

(51) Int. Cl. B32B 33/00; C09J 7/02; B32B 7/00

(52) U.S. Cl. 428/202; 428/409

(57) ABSTRACT

Disclosed is a transfer-foil raw fabric and a peeling film therefore having no printed layer for partially controlling peel property and having no foil fall when slitting a transfer-foil into proper width for transfer. The transfer-foil raw fabric is characterized in that a peeling layer is formed all over a peeling film, at least a pattern layer is laminated over the peeling layer, and in that the peeling face of the peeling film which corresponds to the slitting position of the transfer-foil raw fabric is subjected to an easy-adhesion treatment by a surface modification in a band-like shape.

### BACKGROUND OF THE INVENTION

1. Technical Field

The present invention relates to a transfer-foil raw fabric with no foil fall at the time of slitting the film into a width proper for transfer and a peeling film therefor.

2. Description of the Related Art

Conventionally, a thermal transfer method for decoration has been known, which involves closely attaching a transfer foil made by laminating a transfer layer including a peeling layer, a pattern layer, an adhesive layer, etc., on a peeling film to an object to be decorated such as a plastic molded product, a glass molded product, a metal molded product, etc. by heating and pressurizing and thereafter, transferring only the transfer layer to the surface of the object to be decorated by peeling the peeling film.

Further, in a case where the object to be decorated is a plastic molded product, a method also known is a molding simultaneous transfer method for carrying out decoration by sandwiching a transfer foil in a molding die, injecting and filling a resin in the cavity, and obtaining a plastic molded product and simultaneously closely attaching a transfer layer to the surface of the product, and transferring only the transfer layer to the surface of the object to be decorated by peeing a peeling film.

A transfer foil to be used for the thermal transfer method and for the molding simultaneous transfer method is used in such a manner that an raw fabric of a transfer foil 109 is generally produced with a wide width as shown in FIG. 5 and is thereafter slit in a proper width corresponding to the size of an object 108 to be decorated since it is not economical if the sheet is produced separately for a width corresponding to the size of the object to be decorated at the time of transfer.

However, in this case, there is a disadvantage that “foil fall” is caused due to the shock at the time when a blade hits the slitting part of a transfer foil raw fabric 100, that is, peeling of the transfer layer from the peeling film occurs. It is because the peeling property between the peeling film of the transfer foil and the transfer layer is excellent in not only portions which are subjected to the transfer but also portions which are not subjected to the transfer.

This disadvantage is more significant as a whole in a case where the thickness of the transfer layer is thicker, for example, in a case where there are many pattern layers as the transfer layer, or in a case where a vapor-deposition layer needs to be formed as the pattern layer, or in a case where the peeling layer inevitably becomes thick like a hard coat foil, or in a case where there are many functional layers, etc.

As a result, the foil falling fragments are stuck to the transfer foil 109 with a prescribed width obtained by slitting the raw fabric and are incorporated as dusts between the object 108 to be decorated and the transfer layer at the time of transfer. Further, besides the above-mentioned phenomenon, in the case of the molding simultaneous transfer method, the falling fragments of the foil stuck to the rear surface of the transfer foil 109 are transferred to the molding die to generate dots-like recessed parts called as dents in the surface of a plastic molded product.

As a countermeasure for the foil fall, as shown in FIG. 6, a transfer foil raw fabric 100 is known, which has a foil fall-prevention layer 102 that does not cause interlayer separation between a peeling film 101 and a transfer layer and is formed like a band between the peeling film 101 and the transfer layer in the slitting part of the transfer foil raw fabric 100 (see Patent Document 1).

Further, as shown in FIG. 7, a transfer foil raw fabric 100 is known, which is obtained by forming a peeling layer 107 on portions excluding a slitting part and forming a foil fall-prevention layer 102 in a manner of covering at least the slitting part of the peeling layer 107 (see Patent Document 2).

Furthermore, as shown in FIG. 8, a transfer foil raw fabric 100 is known, which is obtained by carrying out an easy-adhesion treatment on one surface of a peeling film 101, forming a release layer on a tackiness improved surface 103 excluding a slitting part, successively forming a peeling layer 107 entirely thereon, and further laminating a pattern layer 105 and an adhesive layer 106 thereon (see Patent Document 3).

### PRIOR ART DOCUMENT

### Patent Document

Patent Document 1: JP-U No. 62-65258

Patent Document 2: JP-U No. 62-65259

Patent Document 3: JP-A No. 11-58584

### SUMMARY OF THE INVENTION

### Problems be Solving by the Invention

However, the transfer foil raw fabric 100 shown in FIG. 6 has a portion where the foil fall-prevention layer 102 in a band-like shape rose upward as compared with other portions and in a state where the transfer foil raw fabric 100 is spread, the rise is slight; however in a case where the transfer foil raw fabric with a long length is wound like a roll, the foil fall-prevention layer 102 is overlapped to rise upward significantly and therefore, there is a problem that the transfer foil raw fabric 100 is deformed in a case where the raw fabric roll is stored for a long time.

Further, the transfer foil raw fabric 100 shown in FIG. 7 has the peeling layer 107 of the peeling film 101 formed by pattern printing excluding a slitting part for controlling the peeling property and the foil fall-prevention layer 102 formed on the slitting part over the peeling layer 107, and since a printing step is indispensably carried out, an ink is deposited on portions of the film on which the ink should not be deposited normally; that is, the step is inevitably accompanied with a defection risk, so-called, “scumming”. If scumming with the ink of the peeling layer occurs in portions where the foil fall-prevention layer 102 is formed, the adhesiveness of the surface of the peeling film 101 in the slitting part is deteriorated and thus the foil fall cannot be prevented.

Furthermore, the transfer foil raw fabric 100 shown in FIG. 8 also has a release layer 104 formed by pattern printing on the tackiness improved surface 103 of the peeling film 101 excluding a slitting part for controlling the peeling property; however if scumming with the ink of the peeling layer occurs, the adhesiveness of the surface of the peeling film 101 in the slitting part is deteriorated and thus the foil fall cannot be prevented.

The present invention has been made in consideration of the problems of the conventional techniques as described above, and the invention aims to provide a peeling film for a transfer foil raw fabric and a transfer foil raw fabric without forming a printed layer for partially controlling the peeling property and no foil fall at the time of slitting the peeling film into the width of a transfer foil.

### Means for Solving the Problems

In order to solve the technical problems, the present invention provides a peeling film for a transfer foil raw fabric and a transfer foil raw fabric with the following configurations.

In the present invention, a peeling film for a transfer foil raw fabric having no foil fall to be used as an raw fabric of a transfer foil comprising a peeling layer formed entirely on the peeling film and at least a pattern layer on the peeling layer, wherein

an easy-adhesion treatment in a band-like shape by surface modification is carried out on a peeling surface of the peeling film corresponding to a slitting position in the transfer foil raw fabric.

In case that the peeling film includes a release layer formed entirely on a base film, the release layer surface is subjected to the easy-adhesion treatment.

The easy-adhesion treatment is any one of flame treatment, corona treatment, plasma treatment, UV treatment, EB treatment, laser treatment, solvent or chemical agent treatment.

The peeling film preferably provides an appearance difference distinguishable between a treated region subjected to the easy-adhesion treatment and an untreated region not subjected to the easy-adhesion treatment and the peeling film contains an additive for causing the appearance difference by the easy-adhesion treatment.

The appearance difference is based on the difference of color types, luster difference, brightness difference, chromaticness difference, or combinations thereof.

In the present invention, a transfer foil raw fabric having no foil fall comprising a peeling film, a peeling layer formed entirely on the peeling film and at least a pattern layer on the peeling layer, wherein

an easy-adhesion treatment in a band-like shape by surface modification is carried out on a peeling surface of the peeling film corresponding to a slitting position of the transfer foil raw fabric.

In case that the peeling film includes a release layer formed entirely on a base film, the release layer surface is subjected to the easy-adhesion treatment.

The easy-adhesion treatment is any one of flame treatment, corona treatment, plasma treatment, UV treatment, EB treatment, laser treatment, solvent or chemical agent treatment.

The peeling film preferably provides an appearance difference distinguishable between a treated region subjected to the easy-adhesion treatment and an untreated region not subjected to the easy-adhesion treatment and the peeling film contains an additive for causing the appearance difference by the easy-adhesion treatment.

The appearance difference is based on the difference of color types, luster difference, brightness difference, chromaticness difference, or combinations thereof.

### EFFECTS OF THE INVENTION

The peeling raw fabric for a transfer foil and the transfer foil of the present invention have the following configurations and therefore have the following excellent effects.

That is, since the peeling surface of the peeling film is subjected to the easy-adhesion treatment in a band-like shape by surface modification in the slitting part of the transfer foil raw fabric, when the transfer foil raw fabric is slit to give a proper width for transfer, interlayer separation is not caused between the peeling film and the transfer layer and thus the foil fall can be prevented.

Moreover, it is no need to form a printed layer for partially controlling the peeling property unlike countermeasures for conventional foil fall, risks of deformation of the transfer foil raw fabric due to rising upward in the slitting part or loss of adhesiveness of the peeling film surface in the slitting part due to scumming are removed.

### BRIEF DESCRIPTION OF THE DRAWINGS

FIG. 1 is a perspective view of a main part showing one example of the peeling film for a transfer foil raw fabric of the present invention.

FIG. 2 is a perspective view of a main part showing another example of the peeling film for a transfer foil raw fabric of the present invention.

FIG. 3 is a perspective view showing one example of a transfer foil raw fabric using the peeling film shown in FIG. 1.

FIG. 4 is a perspective view showing one example of a transfer foil raw fabric using the peeling film shown in FIG. 2.

FIG. 5 is an explanatory view for a method for slitting a transfer foil raw fabric.

FIG. 6 is a perspective view of a main part showing the transfer foil raw fabric of a conventional technique.

FIG. 7 is a perspective view of a main part showing another example of the transfer foil raw fabric of a conventional technique.

FIG. 8 is a perspective view a main part showing further another example of the transfer foil raw fabric of a conventional technique.

FIG. 9 is a perspective view showing the general printing state of gravure rotary printing.

FIG. 10 is an explanatory view showing a defective example generated in a case where a region subjected to an easy-adhesion treatment is not distinguished.

FIG. 11 is an explanatory view showing a state where a region subjected to an easy-adhesion treatment and a region not subjected to the treatment are distinguishable.

FIG. 12 is an explanatory view showing the configuration of an apparatus for carrying out an easy-adhesion treatment by plasma treatment and distinction mark formation by laser treatment in a same line.

### DETAILED DESCRIPTION OF THE INVENTION

Hereinafter, the present invention will be described in more detail according to embodiments shown in drawings.

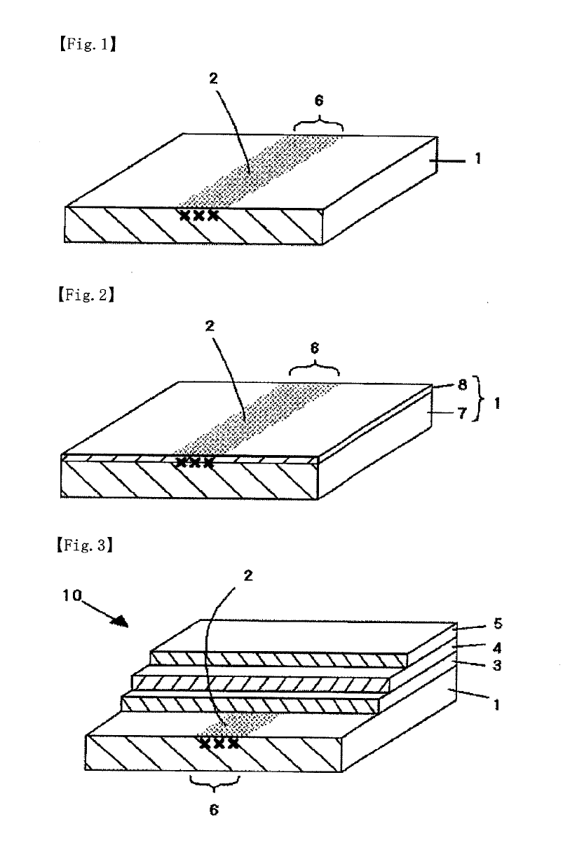

FIG. 1 is a perspective view showing one example of the peeling film for a transfer foil raw fabric of the present invention.

In FIG. 1, with respect to the peeling film for a transfer foil raw fabric (hereinafter, abbreviated as a peeling film), the peeling surface of the peeling film 1 is subjected to an easy-adhesion treatment in a band-like shape by surface modification in a slitting part 6 of a transfer foil raw fabric 10 (see FIG. 3).

FIG. 3 is a perspective view showing one example of the transfer foil raw fabric 10 using the peeling film 1. In FIG. 3, a peeling layer 3 is formed entirely on the peeling film 1 and a pattern layer 4 and an adhesive layer 5 are successively laminated on the peeling layer 3.

As the peeling film 1, those commonly used as a base film for a transfer foil are usable and examples thereof include simple substance films such as a polyethylene-based resin, a polypropylene-based resin, a polyester-based resin, a polyamide-based resin, a polyacrylic-based resin, and a poly(vinyl chloride)-based resin or composites thereof, or composites of these films with paper or the like.

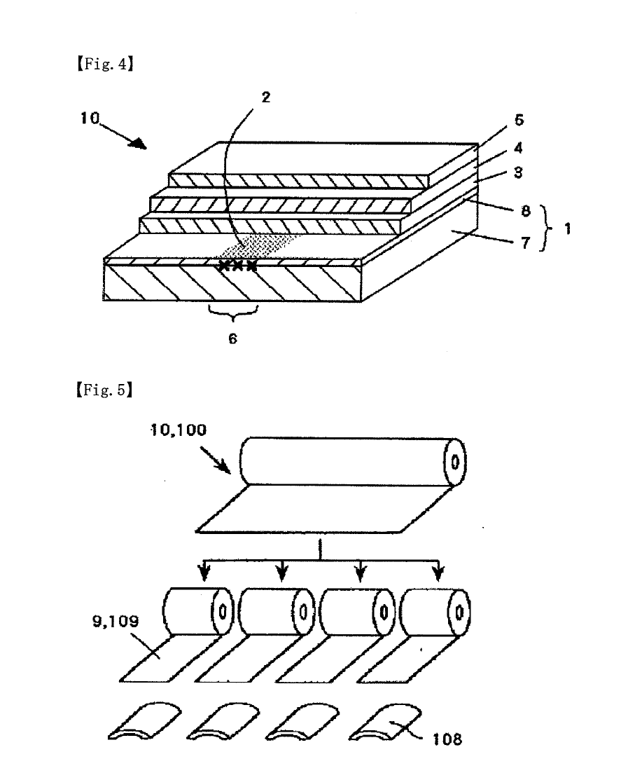

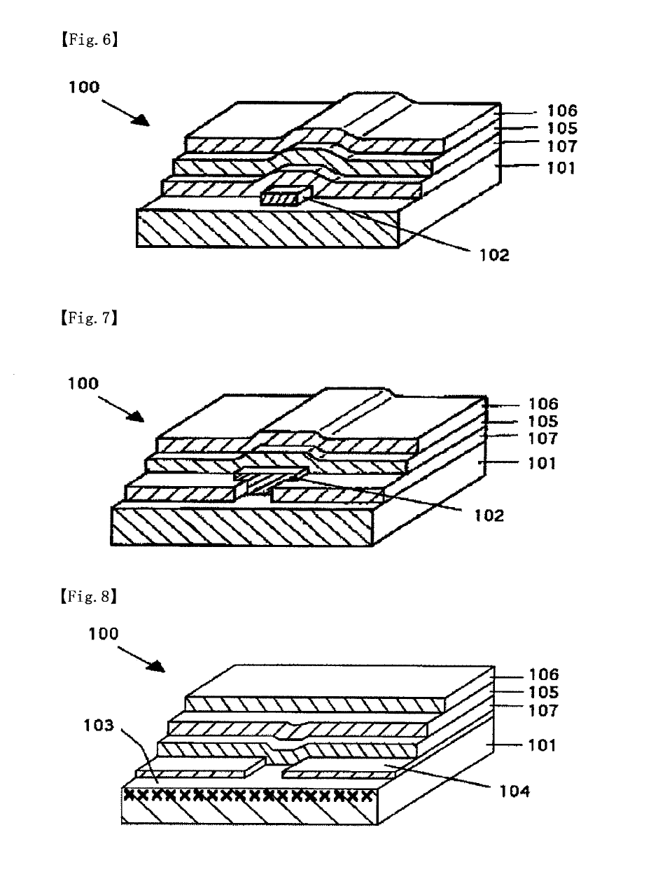

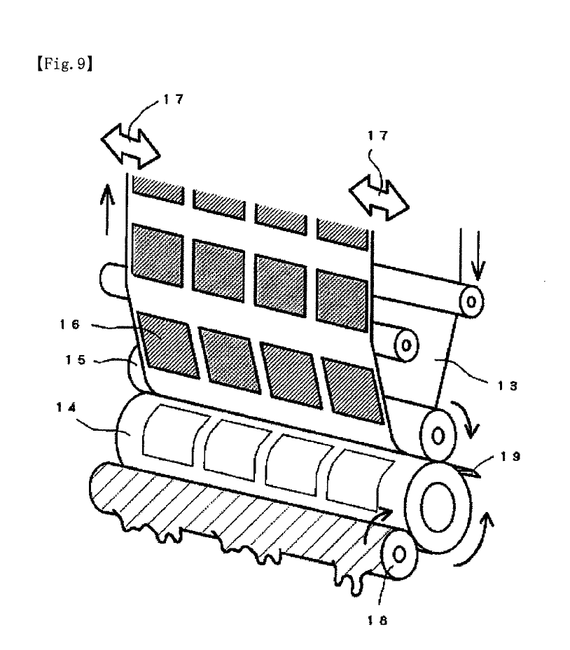

Further, as shown in FIGS. 2 and 4, the peeling film 1 may include a film material as a base film 7 and a release layer 8 formed entirely thereon.

The release layer 8 is a layer to be released from the peeling layer 3 together with the base film 7 at the time of separating the peeling film 1 after thermal transfer or current molding transfer.

A material of the release layer 8 may be an epoxy resin-type release agent, an epoxy-melamine resin-type release agent, a melamine resin-type release agent, a silicone resin-type release agent, a fluorine resin-type release agent, a cellulose derivative-type release agent, an alkyl resin-type release agent, a urea resin-type release agent, a polyolefin resin-type release agent, a paraffin-type release agent, and composite type release agents thereof.

A method for forming the release layer 8 on the entire surface of the base film 7 may be a printing method such as gravure printing, screen printing, and flexo printing and a coating method such as reverse coat. These methods may be carried out in an off-line manner after film formation of the based film 7; however it is also possible to form the layer by coating the release agent (in-line coating) in the same line as that for forming the base film 7.

In the peeling surface of the peeling film 1, the easy-adhesion treatment is carried out in a band-like shape in the slitting part 6 of the transfer foil raw fabric 10 (the reference numeral 2 in FIGS. 2 and 4 shows a tackiness improved part).

The easy-adhesion treatment is a treatment for close adhesion so as not to separate the peeling layer 3 from the peeling film 1 at the time of slitting the transfer foil raw fabric 10 in order to have a proper transfer foil width for transfer.

Specific examples of the easy-adhesion treatment include flame treatment, corona treatment, plasma treatment, UV treatment, EB treatment, laser treatment, solvent/agent treatment, etc.

These easy-adhesion treatments are through surface modification of the peeling film 1 but not through forming a new layer having a function of the tackiness improving property on the peeling film 1. Consequently, even if the easy-adhesion treatment is carried out in a band-like shape, the peeling film 1 is not thickened more in the tackiness improved part in a band-like shape as compared with other portions.

That is, since no foil fall-prevention layer is overlapped and risen upward at the time of winding the transfer foil raw fabric having the peeling film, deformation of the transfer foil raw fabric can be solved.

The flame treatment is generally a treatment in which a combustible gas such as propane gas is burned on the film surface while blowing oxygen to cause oxidation reaction and a basic group having polarity is produced on the film surface.

The corona treatment is a treatment in which a discharge treatment is carried out on the film surface to produce a carboxyl or hydroxyl group having polarity on the film surface and the surface is roughened.

The plasma treatment is generally a treatment in which a basic group having polarity is produced on the film surface by utilizing the electric charge of particles generated by the electrolytic dissociation of a gas on the film surface.

The UV treatment is generally a treatment in which the ambient radicals are produced by high energy ultraviolet rays and simultaneously the bonds among molecules of the film surface are cut by the energy of ultraviolet rays and thus the film surface is subjected to a hydrophilic treatment or oxidative evaporation.

The EB treatment is generally a treatment in which the film is irradiated by electron beam through an electron beam radiation apparatus and the bonds among molecules of the film surface are cut by the energy of electron beam and thus the film surface is subjected to a hydrophilic treatment or oxidative evaporation.

The laser treatment is generally a treatment in which the film surface is irradiated by laser beam such as CO₂ laser, argon laser, or the like and the bonds among molecules of the film surface are cut by the energy of laser beam and thus the film surface is subjected to a hydrophilic treatment or oxidative evaporation.

The solvent/agent treatment is generally a treatment in which the film surface is brought into contact with a solvent/agent to modify (including surface-roughening) the surface. Additionally, in the case of using a solvent, it is unnecessary because the solvent is evaporated; whereas in the case of using an agent, the agent is removed by washing after the surface modification.

These easy-adhesion treatments can be carried out in the form of a band-like shape for the peeling film 1 or in the form of a band-like pattern for the needed parts by masking other portions which should not be treated.

The slitting part 6 is a part with a width of about 5 to 10 mm around a line planed to be slit as a center in the transfer foil. In addition, the width of the slitting part 6 may be widened although it is more or less uneconomical. However, narrowing the width of the slitting part 6 becomes a problem in terms of the slitting precision. That is, in a case where the extent of meandering generated at the time of transportation of the peeling film 1 while being unwound is significant, there is a risk that a slitting blade would be detached from the slitting part 6.

The peeling film 1 is easy to be separated from the peeling layer 3 in the portions where the easy-adhesion treatment in a band-like shape is not carried out. Specifically, a peel strength test in the 90° direction is carried out by peeling a tape (adhesive tape used: Cellotape (registered trade name), manufactured by Nichiban Co., Ltd.; tape width: 18 mm; peeling test speed: 20 mm/min; peeling length: 30 mm) with a push-pull gauge to find that the peel strength is 0 to 11 g.

On the other hand, the peel strength of the slitting part 6 subjected to the easy-adhesion treatment is 85 g or higher.

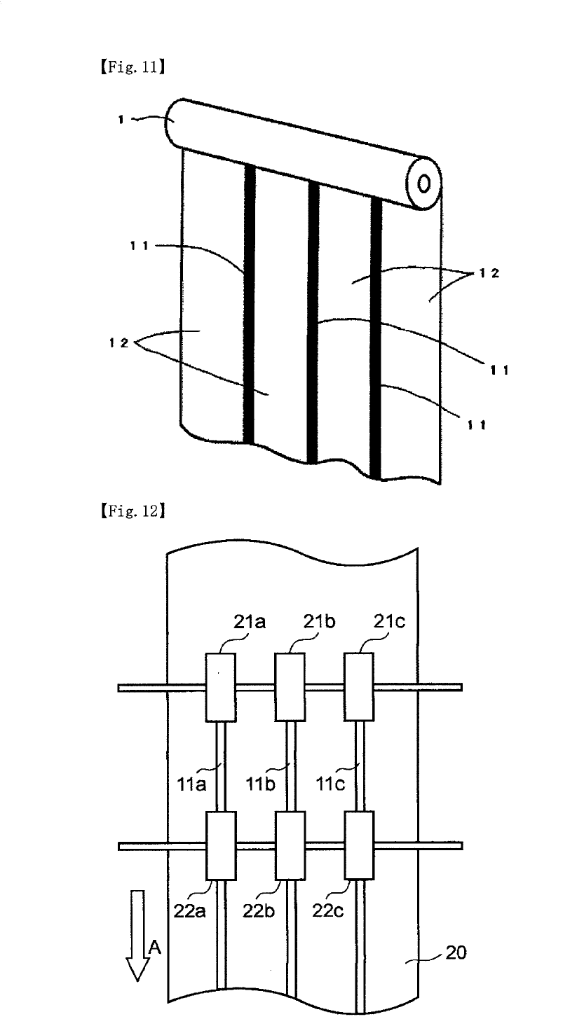

Incidentally, in the peeling surface of the peeling film 1, in a case where a treated region 11 subjected to the easy-adhesion treatment and an untreated region 12 of the peeling film 1 (see FIG. 11) are not distinguished even if the slitting part of the transfer foil raw fabric 10 is subjected to the easy-adhesion treatment in a band-like shape by surface modification, there occurs a problem at the time of printing the pattern layer 4 in a later step.

Hereinafter, the problem will be described in more detail.

First, FIG. 9 shows the situation of common gravure rotary printing.

A plate cylinder 14 is a cylinder-like plate having small holes (dents) and the ink applied to a furnisher roll 18 is transferred to the entire surface of the plate cylinder 14 and the ink on a portion having no holes (non-printing part) is scraped off by a doctor 19 and the ink remaining in the holes is pushed by an impression cylinder 15 and transferred to a film 13 and as a result, a printed pattern 16 is formed.

One of printing defects generated in this printing step is a position gap 17 between a printing plate formed in the plate cylinder 14 and the film 13 to be printed in the width direction.

In the case of a common transfer foil, since the position adjustment in relation to an object to be decorated is carried out at the time of transfer, even if the position gap 17 is generated in the printing step before slitting in the width direction, it does not result in defects in a case where the entire surface is a monochromic pattern.

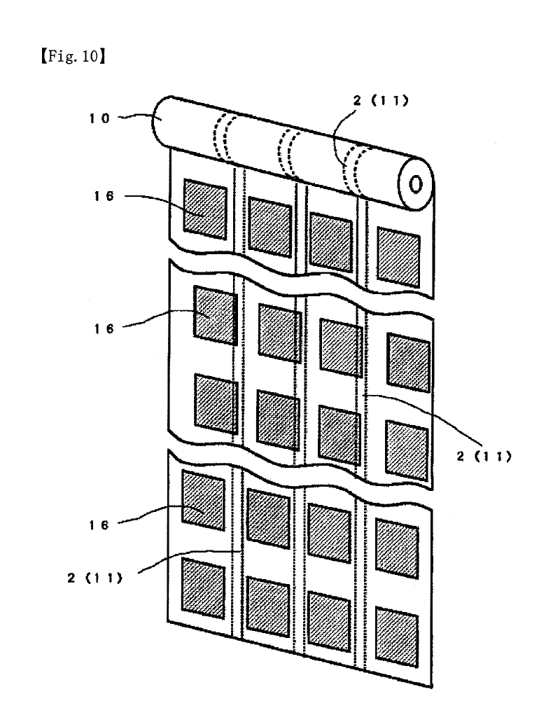

However, like the present invention, in a case where the easy-adhesion treatment in a band-like shape is carried out for the peeling film 1 to be used, if the pattern layer 4 is overlapped on the treated region 11 subjected to the easy-adhesion treatment of the peeling film 1 due to the position gap 17 (see FIG. 10), the overlapped part of the pattern layer 4 causes peeling failure at the time of transfer.

Even so, the loss can be decreased by cutting only the section where the pattern layer 4 and the treated region 11 subjected to the easy-adhesion treatment is carried out are overlapped in the total scale of the obtaining transfer foil raw fabric, however in the state of the transfer foil raw fabric, it is not easy to distinguish the treated region 11 subjected to the easy-adhesion treatment and the untreated region 12 and if the distinction is impossible, whichever section the peeling failure occurs cannot be determined.

Therefore, in the present invention, the peeling film 1 is so configured as to have an appearance difference to distinguish the treated region 11 subjected to the easy-adhesion treatment and the untreated region 12 (see FIG. 11) and in a case where the pattern layer 4 overlaps on the treated region 11 subjected to the easy-adhesion treatment due to the position gap through the succeeding printing step, it is made easy to find the defective section and remove the section.

Herein, the appearance difference may be, for example, a difference of color types between the treated region 11 subjected to the easy-adhesion treatment and the untreated region 12.

Further, the appearance difference may be a gloss difference between the treated region 11 subjected to the easy-adhesion treatment and the untreated region 12.

Alternatively, the appearance difference may be both differences; the difference of color types and the gloss difference.

Furthermore, if it is possible to obtain an appearance difference distinguishable between the treated region 11 subjected to the easy-adhesion treatment and the untreated region 12, for example, it may be a brightness difference or chromaticness difference besides color or gloss as a standard.

The appearance difference is not limited to those distinguishable with eyes by reflected light and may be an appearance difference distinguishable with eyes by transmitted light.

Alternatively, the appearance difference may be distinguishable by emitting fluorescence only from the treated region 11 or emitting no fluorescence from the treated region 11 but emitting fluorescence only from the untreated region 12.

Furthermore, the appearance difference may be distinguishable by a camera or sensor even if the distinction is impossible with eyes.

A method for providing the appearance difference for distinguishing the treated region 11 subjected to the easy-adhesion treatment and the untreated region 12 of the peeling film 1 is preferably carried out simultaneously with the easy-adhesion treatment by flame treatment, corona treatment, plasma treatment, UV treatment, EB treatment, laser treatment, solvent/agent treatment, etc.

Specifically, an additive which can generate the appearance difference by any of the above-mentioned easy-adhesion treatments is previously added to the peeling film before the easy-adhesion treatment. That is, not only the easy-adhesion property of the peeling surface is imparted to the slitting part 6 of the transfer foil raw fabric 10 by the easy-adhesion treatment but also an appearance change such as color or gloss is generated simultaneously in the slitting part 6.

Herein, in a case where the appearance change is a color change, besides discoloration to a different color, for example, from red color to blue color, decoloration, color degradation, coloration, and light emission are included. If a color change occurs before and after the easy-adhesion treatment, the color tone, brightness of color, chromaticness, and brightness are not limited.

Examples of the additive include dyes, fluorescent dyes, pigments, materials having photochromism and a proper combination may be appropriately selected among flame treatment, corona treatment, plasma treatment, UV treatment, EB treatment, laser treatment, solvent/agent treatment, etc. for generating the appearance change.

As one example of the combination, in a case where the color is changed by, for example, laser treatment, the following additives may be used.

First, examples thereof include inorganic pigments such as white pigments (titanium dioxide, zinc oxide, antimony trioxide, zinc sulfide, lithopone, basic lead carbonate, basic lead sulfate, basic lead silicate, etc.), metal oxides (iron oxide, chromium oxide, etc.), nickel-antimony titanate, chromium-antimony titanate, manganese blue, manganese violet, cobalt blue, cobalt chromium blue, cobalt nickel gray, ultramarine blue, Berlin blue, lead chromate, lead sulfochromate, molybdate orange, molybdate red, metal sulfides (cadmium sulfide, arsenic disulfide, antimony trisulfide), cadmium sulfoselenides, zirconium silicate, low concentration carbon black, and graphite.

Examples thereof further include organic pigments such as azo, azomethine, methine, anthraquinone, indanthrone, pyranthrone, flavanthrone, benzathrone, phthalocyanine, perinone, perylene, dioxazine, thioindigo, isoindoline, isoindolinone, quinacridone, pyrrole-pyrrole, and quinophthalone pigments, and also metal complexes of azo, azomethine, or methine dyes, and metal salts of azo compounds.

Further, examples thereof include disperse dyes (e.g. anthraquinone type disperse dyes), as well as polymer-soluble dyes such as metal complexes of azo dyes particularly including monoazo dye 1:2 chromium or cobalt complex compounds, as well as fluorescent dyes (e.g. cumarin, naphthalimide, pyrazoline, acrydine, xanthene, thioxanthene, oxazine, thiazine, and benzothiazole type fluorescent dyes).

Furthermore, other examples of the combination include additives such as indigo dyes in the case of changing the color by, for example, plasma treatment.

Moreover, if the appearance difference can be imparted simultaneously with the easy-adhesion treatment by flame treatment, corona treatment, plasma treatment, UV treatment, EB treatment, laser treatment, solvent/agent treatment, etc., even in a case where an additive causing the appearance difference by the easy-adhesion treatment is not previously added to the peeling film before the easy-adhesion treatment, it may be acceptable.

For example, it may include those which cause an appearance change by the falling off of the release layer by the easy-adhesion treatment and those which cause a gloss change due to unevenness of the surface. In a case where the release layer is fallen off by the easy-adhesion treatment, the release layer is removed by the falling off, it results in easy-adhesion.

In a case where the peeling film 1 includes the film material as a base film and the release layer 8 formed entirely thereon, the additive may be added to the base film or the additive may be added to the release layer 8.

Further, another method for imparting a distinguishable appearance difference between the treated region 11 subjected to the easy-adhesion treatment and the untreated region 12 of the peeling film 1 may be carried out by another apparatus or method different from the easy-adhesion treatment to form a distinction mark conforming with the treated region 11 subjected to the easy-adhesion treatment.

For example, an additive which causes the appearance difference by laser treatment is previously added to the peeling film before the easy-adhesion treatment and the easy-adhesion treatment itself is carried out by plasma treatment and successively laser treatment is carried out in the same line with the plasma treatment to form a distinction mark.

In more detail, as shown in FIG. 12, a plurality of plasma exposure heads 21a to 21c are installed in the width direction of a film 20 and plasma generation apparatus is installed in each plasma exposure head 21a to 21c toward the film 20.

The plasma generation apparatus is so configured as to generate plasma in the atmospheric pressure environment and does not require large scale equipments unlike a conventional one for carrying out treatment in a vacuum chamber. Each plasma generation apparatus is connected with a gas source of, for example, argon, helium, nitrogen, oxygen, hydrogen, carbon dioxide, carbon tetrafluoride and steam and a power source and when the film 20 is transported in the direction shown by the arrow A, plasma is radiated from each plasma generation apparatus to the surface of the film to carry out the easy-adhesion treatment, that is, formation of treated regions 11a to 11c in band-like shapes causing no peeling in parallel.

A plurality of leaser printing heads 22a to 22c are installed in the traces of the treated regions 11a to 11c in band-like shapes downstream of the plasma exposure heads 21a to 21c in the film transportation direction to further print the distinction mark for the treated regions 11a to 11c in band-like shapes.

Accordingly, the easy-adhesion treatment and the treatment for imparting an appearance difference for distinguishing the treated region 11 subjected to the easy-adhesion treatment and the untreated region 12 can be carried out in the same line.

Further, an additive which causes the appearance difference by laser treatment is previously added to the peeling film before the easy-adhesion treatment and the easy-adhesion treatment itself is carried out by plasma treatment and at the same time laser treatment is carried out for the surface reverse to the easy-adhesion surface to form a distinction mark.

Furthermore, as a method for imparting an appearance difference more simply, a distinction mark conforming with the treated region 11 subjected to the easy-adhesion treatment may be formed by installing a coloring mechanism such as a pen on the reverse surface to the surface of the peeling film 1 subjected to the easy-adhesion treatment and drawing a line. The conformation in the case of this simple method may not be required to have the same width as that of the treated part.

The peeling layer 3 becomes the outermost layer of the transfer layer transferred to the object to be decorated at the time of peeling the peeling film 1 after the transfer or after the molding simultaneous transfer. However, the peeling layer 3 is formed on the entire surface of the peeling film 1 and a part to be brought into contact with a part 1a in a band-like shape of the peeling film 1 subjected to the easy-adhesion treatment, that is, the slitting part 6 is a layer closely attached to and remaining on the peeling film 1 without being separated from the peeling film 1. Consequently, since the peeling layer 3 is closely attached to the peeling film 1 in the slitting part 6, no foil fall is caused at the time of slitting to give a proper width for transfer.

A material for the peeling layer 3 may be a polyacrylic resin, a polyester-based resin, a poly(vinyl chloride)-based resin, a cellulose-based resin, a rubber-based resin, a polyurethane-based resin, a poly(vinyl acetate)-based resin, as well as copolymers such as a vinyl chloride-vinyl acetate copolymer-based resin and an ethylene-vinyl acetate copolymer-based resin.

In a case where hardness is required for the peeling layer 3, a light cure resin such as an ultraviolet curable resin, a radiation curable resin such as an electron beam-curable resin, and a thermosetting resin may be selected and used. Methods for forming the peeling layer 3 include coating methods such as a gravure coating method, a roll coating method, a comma coating method and a lip coating method, and printing methods such as a gravure printing method and a screen printing method.

The pattern layer 4 is formed generally as a printed layer on the peeling layer 3.

A material for the printed layer may be a colored ink containing, as a binder, resins such as a polyvinyl-based resin, a polyamide-based resin, a polyester-based resin, a polyacrylic resin, a polyurethane-based resin, a polyvinyl acetal-based resin, a polyester urethane-based resin, a cellulose ester-based resin and an alkyd resin, and as a coloring agent, a pigment or dye with proper color.

Methods for forming the printed layer include common printing methods such as an offset printing method, a gravure printing method and a screen printing method. Particularly, in order to carry out multicolor printing or gradation expression, an offset printing method and a gravure printing method are suitable.

In the case of monochrome, coating methods such as a gravure coating method, a roll coating method, a comma coating method and a lip coating method may be employed. The printed layer is generally formed entirely or partially in accordance with a pattern to be expressed.

Further, the pattern layer 4 may include a metal thin film layer or a combination of a printed layer and a metal thin film layer.

The metal thin film layer is for expressing metal luster as the pattern layer 4 and may be formed by a vacuum deposition method or a plating method such as a resistance heating method, a sputtering method and an ion plating method.

In this case, in accordance with the metal luster to be expressed, metals such as aluminum, nickel, gold, platinum, chromium, iron, copper, tin, indium, silver, titanium, lead and zinc, and alloys and compounds thereof may be used.

One example of a method for partially forming a metal thin film layer may be a method in which a solvent-soluble resin layer is formed on a portion where no metal thin film is needed, thereafter a metal thin film is entirely formed thereon, and the solvent-soluble resin layer and unnecessary metal thin film are removed by washing with a solvent. In this case, a solvent to be used often is water or aqueous solution.

Further, another example thereof is a method in which a metal thin film is entirely formed, successively, a resist layer is formed on a portion where the metal thin film is to be left, etching with an acid or alkali is carried out, and thus the metal thin film in the portion other than the portion covered with the resist layer is removed.

At the time of forming the metal thin layer, in order to improve the adhesiveness between the neighboring layer and the metal thin layer, a pre-anchor layer and a post-anchor layer may be formed. Materials for the pre-anchor layer and post-anchor layer may be a two-component curable urethane resin, a thermosetting urethane resin, a melamine-based resin, a cellulose ester-based resin, a chlorine-containing rubber-based resin, a chlorine-containing vinyl-based resin, a polyacrylic resin, an epoxy-based resin, a vinyl type copolymer resin.

Methods for forming the pre-anchor layer and the post-anchor layer include coating methods such as a gravure coating method, a roll coating method, a comma coating method and a lip coating method, and printing methods such as a gravure printing method and a screen printing method.

The adhesion layer 5 is for sticking each of the layers on the surface of the object 8 to be decorated.

The adhesive layer 5 is formed in a portion to be stuck. That is, if the portion to be stuck is the entire surface, the adhesive layer 5 is formed entirely. If the portion to be stuck is partial, the adhesive layer is formed partially.

As the adhesive layer 5, a heat sensitive resin or pressure sensitive resin proper for a material of the object 8 to be decorated is appropriately used. For example, in a case where the material for the object 8 to be decorated is a polyacrylic resin, a polyacrylic resin may be used. Further, in a case where the material for the object to be decorated is a polyphenylene oxide-polystyrene-based resin, a polycarbonate-based resin, a styrene copolymer-based resin, or a polystyrene-based blended resin, a polyacrylic resin, a polystyrene-based resin and a polyamide-based resin having a compatibility with these resins may be used.

Further, in a case where the material for the object 8 to be decorated is a polypropylene resin, a chlorinated polyolefin resin, a chlorinated ethylene-vinyl acetate copolymer resin, cyclized rubber, and a cumarone indene resin are usable. Methods for forming the adhesive layer 5 include coating methods such as a gravure coating method, a roll coating method, a comma coating method and a lip coating method, and printing methods such as a gravure printing method and a screen printing method.

The configuration of the transfer foil raw fabric with no foil fall is not limited to the aspects and if one excellent in adhesiveness to an object to be decorated is used as a material for the pattern layer 4, the adhesive layer 5 can be omitted.

### EXAMPLES

### Example 1

A biaxially stretched polyethylene terephthalate film with a width of 650 mm and a thickness of 38 μm was masked excluding a slitting part of a transfer foil raw fabric 10 and passed at 50 m/min under flames of propane gas to carry out flame treatment on one surface of the film (easy-adhesion treatment) in a band-like shape with a pitch of 150 mm and a width of 10 mm and thus a peeling film for a transfer foil raw fabric was obtained.

Gravure printing with an ink containing a thermoplastic acrylic resin as a main component was carried out on the entire surface of the peeling film to form a peeling layer with a thickness of 1 μm.

Gravure printing of patterns with an ink containing a vinyl-acrylic copolymer resin and a coloring agent as main components was carried out on the peeling layer to form respective pattern layers in the total thickness of 5 μm.

Gravure printing with an ink containing an acrylic-based resin as a main component was carried out on the peeling layer and pattern layers to form an adhesive layer with a thickness of 2 μm and thus a transfer foil raw fabric was obtained.

### Example 2

Using a biaxially stretched polyethylene terephthalate film with a width of 650 mm and a thickness of 38 μm as a base film, gravure printing with an ink containing an epoxy melamine resin as a main component was carried out on one surface of the film and then the film was heated at 170° C. for 20 seconds to entirely form a release layer with a thickness of about 1 μm.

Next, the release layer was masked excluding a slitting part of a transfer foil raw fabric and the release layer was irradiated by plasma from above to carry out plasma treatment on the surface of the film on which the release layer was formed (easy-adhesion treatment) in a band-like shape with a pitch of 150 mm and a width of 10 mm and thus a peeling film for a transfer foil raw fabric was obtained. Thereafter, a transfer foil raw fabric was obtained in the same manner as in Example 1.

### Example 3

Using a biaxially stretched polyethylene terephthalate film with a width of 650 mm and a thickness of 38 μm as a base film, gravure printing with an ink containing an epoxy melamine resin as a main component was carried out on one surface of the film and then the film was heated at 170° C. for 20 seconds to entirely form a release layer with a thickness of about 1 μm.

Next, the release layer was masked excluding a slitting part of a transfer foil raw fabric and the release layer was irradiated by UV rays from above to carry out an easy-adhesion treatment on the surface of the film on which the release layer was formed in a band-like shape with a pitch of 150 mm and a width of 10 mm and thus a peeling film for a transfer foil raw fabric was obtained. Thereafter, a transfer foil raw fabric was obtained in the same manner as in Example 1.

### Example 4

Using a biaxially stretched polyethylene terephthalate film with a width of 650 mm and a thickness of 38 μm as a base film, gravure printing with an ink containing an epoxy melamine resin as a main component was carried out on one surface of the film and then the film was heated at 170° C. for 20 seconds to entirely form a release layer with a thickness of about 1 μm.

Next, the release layer was masked excluding a slitting part of a transfer foil raw fabric and corona treatment was carried out thereon to carry out an easy-adhesion treatment on the surface of the film on which the release layer was formed in a band-like shape with a pitch of 150 mm and a width of 10 mm and thus a peeling film for a transfer foil raw fabric was obtained. Thereafter, a transfer foil raw fabric was obtained in the same manner as in Example 1.

With respect to the respective transfer foil raw fabrics obtained in Examples 1 to 4, when the band-like parts subjected to easy-adhesion treatments were slit, no foil fall was generated at all.

### Example 5

At the time of film formation of a biaxially stretched polyethylene terephthalate film with a width of 650 mm and a thickness of 38 μm, a silicone layer with thickness of 0.02 μm and colored with a pale concentration with an indigo dye was formed entirely on one surface of the film as a release layer by an in-line coating method.

Plasma treatment with argon+oxygen gas was carried out on the release layer surface of the film on which the release layer was formed, that is, the peeling surface, in a band-like shape (band width of 10 mm, and pitch of 150 mm) along with the longitudinal direction of the film to obtain a peeling film.

The indigo dye was discolored by the plasma treatment and the color became almost colorless to form an appearance difference distinguishable between a treated region subjected to the easy-adhesion treatment and an untreated region of the peeling film.

Gravure printing using an ink containing a thermoplastic acrylic resin as a main component was entirely carried out on the peeling film to form a peeling layer with a thickness of 1 μm.

Gravure printing of patterns with an ink containing a vinyl-acrylic copolymer resin and a coloring agent as main components was carried out on the peeling layer to form respective pattern layers in the total thickness of 5 μm.

Gravure printing with an ink containing an acrylic resin as a main component was carried out on the peeling layer and pattern layers to form an adhesive layer with a thickness of 2 μm and thus a transfer foil was obtained.

### Example 6

At the time of film formation of a biaxially stretched polyethylene terephthalate film with a width of 650 mm and a thickness of 38 μm, a silicone layer with thickness of 0.02 μm and colored with a pale concentration with an indigo dye was formed entirely on one surface of the film as a release layer by an in-line coating method.

CO₂ laser treatment was carried out on the release layer surface of the film on which the release layer was formed, that is, the peeling surface, in a band-like shape (band width of 10 mm, and pitch of 150 mm) along with the longitudinal direction of the film to obtain a peeling film.

The peeling layer colored with the indigo dye was dropped off the film by the laser treatment and the color became colorless and the lust was eliminated because the surface of the film became uneven to form an appearance difference distinguishable between a treated region subjected to the easy-adhesion treatment and an untreated region of the peeling film.

A peeling layer, a pattern layer, and an adhesive layer were formed in the same manner as in Example 1 on the peeling film to obtain a transfer foil.

With respect to the transfer foil raw fabrics obtained in Examples 1 and 2, when the band-like parts subjected to the easy-adhesion treatment were slit, no foil fall was generated at all.

Further, since the peeling films had an appearance difference distinguishable between the treated region subjected to the easy-adhesion treatment and the untreated region of the peeling film, even if a defective section where the pattern layer was overlapped on the region subjected to the easy-adhesion treatment was generated due to a position gap in the printing step, merely the defective section could be easily removed based on the appearance difference and when transfer was carried out using the transfer foil after slitting, no peeling defects of the pattern layer occurred.

A proper combination of the arbitrary embodiments among the various embodiments makes it possible to exert effects which the respective embodiments have. While the present invention has been fully described in relation to preferred embodiments with reference to accompanying drawings, various modifications and alterations are apparent to those skilled in the art. Such modifications and alterations should be construed within the present invention as long as without departing from the scope of the invention as defined by the claims.

### INDUSTRIAL APPLICABILITY

The present invention provide a peeling film for a transfer foil raw fabric and a transfer foil raw fabric to be use for a thermal transfer method and a molding simultaneous transfer method.

1. A peeling film for a transfer foil raw fabric having no foil fall to be used as an raw fabric of a transfer foil comprising a peeling layer formed entirely on the peeling film and at least a pattern layer on the peeling layer, wherein
an easy-adhesion treatment in a band-like shape by surface modification is carried out on a peeling surface of the peeling film corresponding to a slitting position in the transfer foil raw fabric.

2. The peeling film for a transfer foil raw fabric having no foil fall according to claim 1, wherein the peeling film includes a release layer formed entirely on a base film and the release layer surface is subjected to the easy-adhesion treatment.

3. The peeling film for a transfer foil raw fabric having no foil fall according to claim 1 or 2, wherein the easy-adhesion treatment is any one of flame treatment, corona treatment, plasma treatment, UV treatment, EB treatment, laser treatment, solvent or chemical agent treatment.

4. The peeling film for a transfer foil raw fabric having no foil fall according to claim 1, wherein the peeling film provided with an appearance difference distinguishable between a treated region subjected to the easy-adhesion treatment and an untreated region not subjected to the easy-adhesion treatment.

5. The peeling film for a transfer foil raw fabric having no foil fall according to claim 4, wherein the peeling film contains an additive for causing the appearance difference by the easy-adhesion treatment.

6. The peeling film for a transfer foil raw fabric having no foil fall according to claim 4 or 5, wherein the appearance difference is based on the difference of color types, luster difference, brightness difference, chromaticness difference, or combinations thereof.

7. A transfer foil raw fabric having no foil fall comprising a peeling film, a peeling layer formed entirely on the peeling film and at least a pattern layer on the peeling layer, wherein
an easy-adhesion treatment in a band-like shape by surface modification is carried out on a peeling surface of the peeling film corresponding to a slitting position of the transfer foil raw fabric.

8. The transfer foil raw fabric having no foil fall according to claim 7, wherein the peeling film includes a release layer formed entirely on a base film and the release layer surface is subjected to the easy-adhesion treatment.

9. The transfer foil raw fabric having no foil fall according to claim 7 or 8, wherein the easy-adhesion treatment is any one of flame treatment, corona treatment, plasma treatment, UV treatment, EB treatment, laser treatment, solvent or chemical agent treatment.

10. The transfer foil raw fabric having no foil fall according to claim 7, wherein the peeling film provided with an appearance difference distinguishable between a treated region subjected to the easy-adhesion treatment and an untreated region not subjected to the easy-adhesion treatment.

11. The transfer foil raw fabric having no foil fall according to claim 10, wherein the peeling film contains an additive for causing the appearance difference by the easy-adhesion treatment.

12. The transfer foil raw fabric having no foil fall according to claim 10, wherein the appearance difference is based on the difference of color types, luster difference, brightness difference, chromaticness difference, or combinations thereof.
